(19) United States
(12) Patent Application Publication
(10) Pub. No.: US 2025/0348142 A1
(43) Pub. Date: Nov. 13, 2025

(54) INFORMATION PROCESSING METHOD AND INFORMATION PROCESSING SYSTEM

(71) Applicant: Panasonic Intellectual Property Management Co., Ltd., Osaka (JP)

(72) Inventors: TORU TANIGAWA, Osaka (JP); HIROTO YANAGAWA, Osaka (JP); HIROSHI MARUYAMA, Osaka (JP); YUMIKO OHNO, Osaka (JP); YOSHIYUKI OKIMOTO, Nara (JP); HIDETAKA SAKAI, Tokyo (JP)

(21) Appl. No.: 19/276,074

(22) Filed: Jul. 22, 2025

Related U.S. Application Data
(63) Continuation of application No. PCT/JP2024/000892, filed on Jan. 16, 2024.

(30) Foreign Application Priority Data
Feb. 7, 2023 (JP) 2023-017109

(51) Int. Cl. G06F 3/01; G09G 3/00

(52) U.S. Cl. CPC G06F 3/013; G09G 3/001; G09G 2320/0613; G09G 2320/0686; G09G 2354/00; G09G 2380/10

(57) ABSTRACT

An information processing device displays a content image on a display, determines whether or not a user's gaze is directed toward a work medium for the user to perform a task, and performs, in a case where it is determined that the user's gaze is directed toward the work medium, a process for changing a mode of the content image displayed on the display so that a level of visual attention of the user decreases.

### BACKGROUND

### 1. Technical Field

The present disclosure relates to a technology for presenting content images.

### 2. Description of the Related Art

Japanese Unexamined Patent Application Publication No. 2012-160173 discloses a technology for detecting the amount of head movement of a user from an image of the user captured by a camera, determining whether or not the user is in a state of concentration on the basis of the amount of head movement, and setting, in a case where it is determined that the user is in a state of concentration, a liquid crystal controllable partition installed around the user to an opaque state.

Japanese Unexamined Patent Application Publication No. 2001-186489 discloses a technology for recognizing a user's body movement from an image of the user captured by a camera, determining whether or not the user is concentrating on a task from the recognition result of the body movement, and reducing, in a case where it is determined that the user is concentrating on a task, the image quality of the display screen for videoconference software displayed on the display.

### SUMMARY

However, in the above-mentioned existing technology, it is not determined whether or not the user's gaze is directed toward the user's work medium, and thus it cannot be accurately determined whether or not the user is concentrating on a task performed using the work medium. Thus, the above-mentioned existing technology cannot display content images in an appropriate mode on the basis of whether or not the user is concentrating on a task performed using the work medium, and the decline in the user's concentration on such a task cannot be suppressed.

One non-limiting and exemplary embodiment provides a technology for suppressing the decline in users' concentration on tasks performed using work media.

In one general aspect, the techniques disclosed here feature an information processing method performed by a computer, the information processing method including: displaying a content image on a display, determining whether or not a user's gaze is directed toward a work medium for the user to perform a task, and changing, in a case where it is determined that the user's gaze is directed toward the work medium, a mode of the content image displayed on the display so that a level of visual attention of the user decreases. This comprehensive or specific aspect may be realized by a device, system, integrated circuit, computer program, or computer-readable recording medium, or any combination of a device, system, integrated circuit, computer program, and computer-readable recording medium. Examples of the computer-readable recording medium include non-volatile recording media, such as a compact disc read-only memory (CD-ROM).

According to the present disclosure, it is possible to suppress the decline in users' concentration on tasks performed using work media.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a booth in which an information processing method according to an embodiment of the present disclosure is applied;

FIG. 2 is a block diagram illustrating an example of the configuration of an information processing system according to an embodiment of the present disclosure;

FIG. 3 is a diagram illustrating an example of a process performed by the information processing system according to the embodiment of the present disclosure;

FIG. 4 includes diagrams illustrating an example of the change of the mode of a content image;

FIG. 5 includes diagrams illustrating another example of the change of the mode of the content image;

FIG. 6 includes diagrams illustrating yet another example of the change of the mode of the content image;

FIG. 7 is a diagram illustrating yet another example of the change of the mode of the content image;

FIG. 8 is a diagram illustrating yet another example of the change of the mode of the content image;

FIG. 9 is a diagram illustrating an example of a vehicle;

FIG. 10 is a diagram schematically illustrating an example of the scene when looking at the front seats from the rear seats illustrated in FIG. 9;

FIG. 11 is a diagram illustrating an example of a case where users use the booth; and

FIG. 12 is a diagram illustrating an example of a process performed by the information processing system in a configuration assuming that users use the booth.

### DETAILED DESCRIPTIONS

### Underlying Knowledge Forming Basis of the Present Disclosure

Technology is being considered that enhances a user's sense of excitement, sense of relaxation, and concentration and work productivity by displaying a content image, examples of which include the user's favorite images such as landscape images, as the background image on a display installed on the inside wall of a private booth where the user performs tasks.

However, in a case where a user is concentrating on a task performed using a work medium such as a personal computer, when a content image is displayed on the display, the user's attention may be directed to the content image, and this may reduce the user's concentration on the task.

In a case where a user is concentrating on a task performed using a work medium, the user's gaze is directed toward the work medium, and thus it is possible to determine whether or not the user is concentrating on such a task on the basis of whether or not the user's gaze is directed toward the work medium.

In Japanese Unexamined Patent Application Publication No. 2012-160173 mentioned above, whether or not a user is in a state of concentration is determined on the basis of the amount of head movement of the user, and determining whether or not the user's gaze is directed toward their work medium is not performed. In Japanese Unexamined Patent Application Publication No. 2001-186489 mentioned above, whether or not a user is concentrating is determined on the basis of the user's body movements, and determining whether or not the user's gaze is directed toward their work medium is not performed.

Thus, according to Japanese Unexamined Patent Application Publication Nos. 2012-160173 and 2001-186489, it is not possible to accurately determine whether or not a user is concentrating on a task performed using a work medium. Thus, content images cannot be displayed in an appropriate mode on the basis of whether or not a user is concentrating on a task performed using a work medium, and the decline in the user's concentration on such a task cannot be suppressed.

Moreover, in Japanese Unexamined Patent Application Publication No. 2012-160173, in a case where the level of a user's concentration is high, the user is simply warned that the level of concentration is high, or contact requests to bidirectional communication devices through which third parties request contact with the user are simply limited. Neither displaying a content image that enhances the user's concentration, for example, nor changing the mode of the content image is performed. Japanese Unexamined Patent Application Publication No. 2001-186489 discloses that the image quality of an image displayed on the display is reduced in a case where a user is concentrating on a task. However, this image is an image for displaying, in a list format, the work scenes of members belonging to a certain organizational entity, such as members who work from home, and is not a content image that enhances the user's concentration.

The present inventors have found that it is possible to accurately determine whether or not a user is concentrating on a task performed using a work medium by determining whether or not the user's gaze is directed toward the work medium. The present inventors arrived at the present disclosure based on the knowledge that, in a case where a user's gaze is directed toward a work medium, the decline in the user's concentration on a task performed using the work medium can be suppressed by changing the mode of a content image so that the level of visual attention of the user decreases.
(1) An information processing method according to an aspect of the present disclosure is an information processing method performed by a computer, including: displaying a content image on a display, determining whether or not a user's gaze is directed toward a work medium for the user to perform a task, and changing, in a case where it is determined that the user's gaze is directed toward the work medium, a mode of the content image displayed on the display so that a level of visual attention of the user decreases.

With this configuration, whether or not the user's gaze is directed toward the work medium is determined, and thus it is possible to accurately determine whether or not the user is concentrating on the task performed using the work medium. In a case where it is determined that the user's gaze is directed toward the work medium, the mode of the content image is changed so that the level of visual attention of the user decreases. Thus, the user's concentration on the task is not disturbed, the user's attention is directed to the work medium, and the decline in the user's concentration on such a task can be suppressed. In contrast, in a case where the user's gaze is not directed toward the work medium, the user's attention can be directed to the content image to enhance the user's sense of relaxation, for example, and work productivity can be improved.
(2) In the information processing method described in (1) above, changing the mode of the content image may include obscuring the content image.

With this configuration, in a case where the user's gaze is directed toward the work medium, the content image displayed on the display is obscured, and thus the level of visual attention of the user to the content image is reduced and the user's attention can be directed to the task.
(3) In the information processing method described in (2) above, in a case where it is determined that the user's gaze is directed toward the work medium, a degree of obscuration of the content image may be increased in accordance with a length of time the user's gaze remains directed toward the work medium.

With this configuration, the degree of obscuration of the content image can be increased in accordance with the period of time the user's gaze remains directed toward the work medium, and thus the mode of the content image can be changed naturally.
(4) In the information processing method described in any one of (1) to (3) above, the content image may be a moving image, and changing the mode of the content image may be changing a region corresponding to a moving subject included in the content image to a background image corresponding to the region.

With this configuration, the moving subject portion included in the content image is masked by the background image, and thus the level of visual attention of the user to the content can be reduced.
(5) In the information processing method described in any one of (1) to (4) above, changing the mode of the content image may include reducing luminance of the content image.

With this configuration, the level of visual attention of the user to the content can be reduced by reducing the luminance of the content image.
(6) In the information processing method described in any one of (1) to (5) above, in a case where it is determined that the user's gaze is not directed toward the work medium after changing the mode of the content image, the mode of the content image may be returned to a mode used before changing the mode of the content image.

With this configuration, when the user's concentration on the task is interrupted, the mode of the content image is returned to its original mode, and thus the user's attention can be directed to the content image and the user's sense of relaxation, for example, can be enhanced.
(7) In the information processing method described in any one of (1) to (6) above, the display may include a first display region facing the user and a second display region different from the first display region, displaying the content image on the display may include displaying the content image in the first display region and the second display region, a first content image included in the content image may be displayed in the first display region, a second content image included in the content image may be displayed in the second display region, and changing the mode of the content image may include changing a mode of the first content image and maintaining a mode of the second content image.

With this configuration, in a case where the user's gaze is directed toward the work medium, the mode of the content image displayed in the first display region facing the user is changed, and the mode of the content image displayed in the second display region is maintained, so that the processing load associated with changing the mode of the content image is reduced. Furthermore, since the content image is displayed using the first display region, which faces the user, and the second display region, when the user's gaze is not directed toward the work medium, the content image can be displayed with a greater sense of immersion.
(8) In the information processing method described in any one of (1) to (7) above, the content image may include a first content moving image and a second content moving image having a smaller amount of movement than the first content moving image, and in a case where it is determined that the user's gaze is directed toward the work medium, the first content moving image displayed on the display may be changed to the second content moving image.

With this configuration, in a case where the user's gaze is directed toward the work medium, since the first content moving image is changed to the second content moving image having a smaller amount of movement than the first content moving image, the user's attention can be directed to the work medium and the decline in the user's concentration on the task can be suppressed.
(9) In the information processing method described in any one of (1) to (8) above, the content image may be an image that creates an ambience around the user.

With this configuration, the content image is an image that creates an ambience around the user, and thus the user's sense of relaxation, for example, can be enhanced through the content image.
(10) In the information processing method described in any one of (1) to (9) above, determining whether or not the user's gaze is directed toward the work medium may include performing a determination using sensing data detected by a sensor that detects at least a state of an eye of the user.

With this configuration, whether or not the user's gaze is directed toward the work medium is determined using sensing data detected by the sensor detecting the user's eye state, and thus it is possible to accurately determine whether or not the user's gaze is directed toward the work medium.
(11) An information processing system according to another aspect of the present disclosure, includes a processor, and the processor displays a content image on a display, determines whether or not a user's gaze is directed toward a work medium for the user to perform a task, and performs, in a case where it is determined that the user's gaze is directed toward the work medium, a process for changing a mode of the content image displayed on the display so that a level of visual attention of the user decreases.

With this configuration, an information processing system that can suppress the decline in users' concentration on tasks performed using work media can be provided.

The present disclosure can also be realized as an information processing program that causes a computer to execute each of the characteristic configurations included in such an information processing method, or as an information processing device operated by this information processing program. It goes without saying that such a computer program can be distributed via computer-readable non-transitory recording media such as CD-ROMs or a communications network such as the Internet.

Note that the embodiments described below are all examples, each of which is one specific example of the present disclosure. For example, the numerical values, shapes, structural elements, steps, and sequences of steps illustrated in the following embodiments are examples and are not intended to limit the present disclosure. Among the structural elements in the following embodiments, the structural elements that are not described in the independent claims that indicate the highest level of concept are described as optional structural elements. In addition, the content of each of all embodiments may be combined.

### EMBODIMENTS

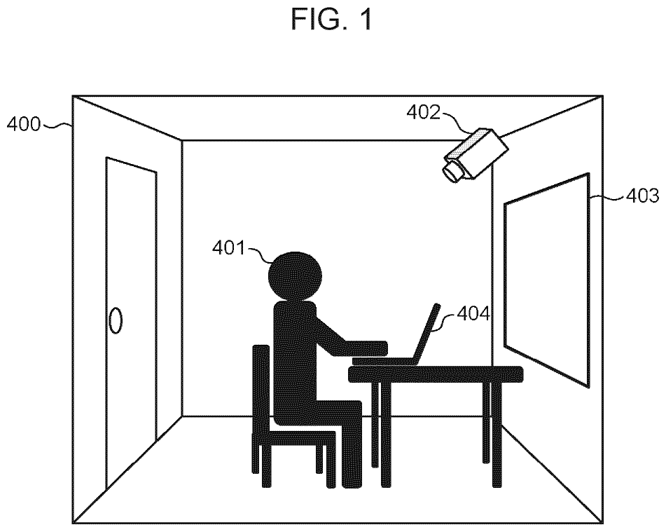

FIG. 1 is a diagram illustrating an example of a booth 400 in which an information processing method according to an embodiment of the present disclosure is applied. The booth 400 is a space for a user 401 to perform tasks using a work medium 404. Examples of the booth 400 include a room of the user 401 where the user 401 works from home, a room in an office, or a space separated by partitions in an office.

In the booth 400, at least a camera 402 that observes the inside of the booth 400 and a screen 403 (an example of a display) that displays content are installed.

An example of the screen 403 is a display device, such as a liquid crystal panel and an organic light-emitting panel. The screen 403 may also be a screen onto which images from a projector are projected. In a case where images are projected using a projector, the screen 403 may be part of the wall surface of the booth 400.

The camera 402 (an example of a sensor) is constituted by an image capturing device that captures images inside the booth 400 at a predetermined frame rate, for example. The camera 402 is installed on the ceiling of the booth 400 such that its optical axis is directed toward the work medium 404 and the user 401 using the work medium 404. The camera 402 is used to observe the user 401, the gaze direction of the user 401, and the work medium 404 of the user 401. Note that, in a case where it is difficult to observe all information using a single camera, cameras may be installed inside the booth 400.

The camera 402 may be installed at any position inside the booth 400 as long as the camera 402 can capture images of the work medium 404 and the user 401 from the position. For example, in a case where the work medium 404 is constituted by a personal computer, a camera installed in the personal computer may be used as the camera 402. The camera 402 may also be installed on or around the table top in a state where the camera 402 is supported by a support such as a tripod or a fixing arm. Moreover, the camera 402 may also be a camera built in a wearable device worn by the user 401.

The screen 403 displays a content image. The content image functions as the background image when the user 401 performs tasks inside the booth 400. The content image may be a favorite image pre-set by the user 401. Examples of the content image include beautiful nature landscape images, images that create the ambience of a café with a moderate amount of bustle, or images that create the ambience of a calm library. The content images may also include healing, animal, or plant-based images. Such a content image creates an ambience around the user 401 performing tasks inside the booth 400, and the images that enhance the user 401's sense of excitement, sense of relaxation, and so forth are used as the content images.

The work medium 404 is an object with which the user performs tasks. Examples of the work medium 404 include a personal computer, a notebook, a book, a tablet computer, and a smartphone. The personal computer can be a stationary computer or a notebook computer.

As a content image, the image selected by the user 401 when the user 401 reserves the booth 400 for use may be used. Moreover, in a case where the booth 400 is equipped with an input device (not illustrated) for selecting a content image, the user 401 may operate this input device to select a content image. Furthermore, speakers (not illustrated) may be provided inside the booth 400 to play a sound that matches the content image.

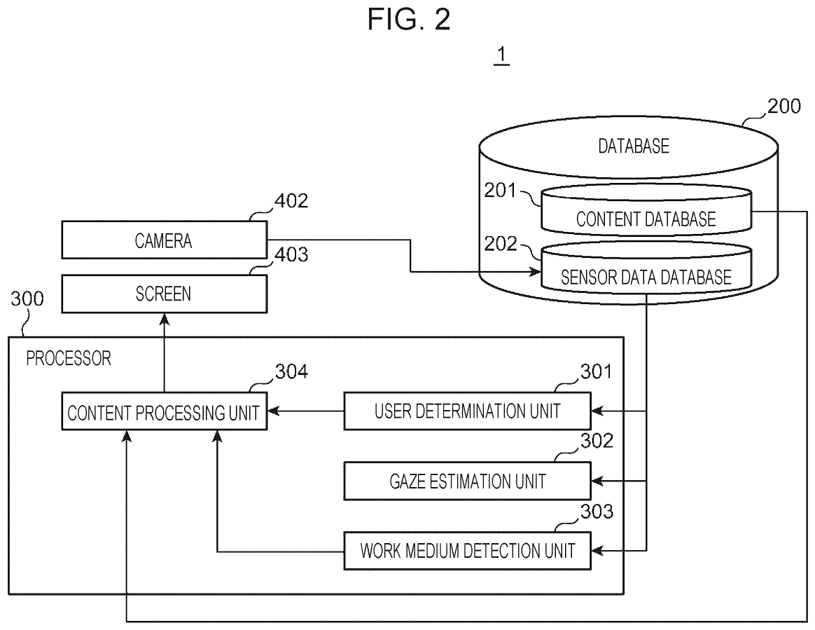

FIG. 2 is a block diagram illustrating an example of the configuration of an information processing system 1 according to an embodiment of the present disclosure. The information processing system 1 includes a database 200 and a processor 300 in addition to the camera 402 and screen 403 illustrated in FIG. 1.

The database 200 includes, for example, a rewritable nonvolatile storage device, such as a hard disk drive and a solid state drive. The database 200 includes a content database 201 and a sensor data database 202.

The content database 201 stores content images to be displayed on the screen 403. The content database 201 may store types of content images that are candidates for display. In this case, the content image selected by the user 401 may be displayed on the screen 403. Note that, in a case where the content image is associated with a playback sound, it is sufficient that the content database 201 associate, with each other, and store the content image and the sound data of the playback sound. The content images may each be a moving image constituted by frame images or a still image.

The sensor data database 202 stores images captured by the camera 402. Such an image may be assigned a timestamp indicating the date and time it was captured. Such an image may also be assigned an identifier for identifying the booth 400.

The processor 300 is, for example, constituted by a central processing unit (CPU). The processor 300 includes a user determination unit 301, a gaze estimation unit 302, a work medium detection unit 303, and a content processing unit 304. The user determination unit 301, gaze estimation unit 302, work medium detection unit 303, and content processing unit 304 may be realized by the CPU executing information processing programs or by dedicated hardware circuits.

The user determination unit 301 reads an image from the sensor data database 202 and uses the read image to determine whether or not the user 401 is present inside the booth 400. The user determination unit 301 determines whether or not the image contains a person using a method such as pattern matching. In a case where the user determination unit 301 determines that the image includes a person, the user determination unit 301 may determine that the user 401 is present inside the booth 400. Alternatively, the user determination unit 301 may determine whether or not the user 401 is present inside the booth 400 by applying face recognition technology to the image. In order to achieve real-time processing, it is sufficient that the user determination unit 301 perform processing for determining whether or not a user is present inside the booth 400 every time an image is stored in the sensor data database 202.

The gaze estimation unit 302 estimates the gaze direction of the user 401 using an image including the user 401. Since the technique for estimating the gaze direction of the user 401 from an image is known, it is sufficient that the gaze estimation unit 302 estimate the gaze direction of the user 401 using this known method. For example, it is sufficient that the gaze estimation unit 302 detect the eye ball position, pupil position, and face orientation of the user 401 from an image including the user 401, and estimate the gaze direction of the user 401 from the detected eye ball position, pupil position, and face orientation. A technique for gaze estimation using eye ball and pupil positions detected from an image is disclosed, for example, in Japanese Unexamined Patent Application Publication No. 2004-21870. Thus, the gaze estimation unit 302 may use this technique to estimate the gaze direction of the user 401. The estimated gaze direction may be a two-dimensional vector or a three-dimensional vector.

The work medium detection unit 303 reads an image from the sensor data database 202 and uses the read image to detect the work medium 404 set inside the booth 400. It is sufficient that the work medium detection unit 303 detect the work medium 404 using, for example, an object detection technique for detecting a specific object from an image. In this case, the type of work medium 404 to be detected is predetermined. Thus, it is sufficient that the work medium detection unit 303 detect the work medium 404 by detecting, from the image, a work medium 404 of the type to be detected. There may be types of work media 404 to be detected. In this case, it is sufficient that the work medium detection unit 303 determine whether or not any one or more work media 404 among work media 404 of all types to be detected are set inside the booth 400. It is sufficient that the work medium detection unit 303 generate, as detection results, the position data and type of the detected work medium 404. The position data of the work medium 404 may be, for example, two-dimensional or three-dimensional. In a case where the position data of the work medium 404 is two-dimensional, two-dimensional coordinates indicating the position of the work medium 404 in the image, for example, are used as the position data. In a case where the position data of the work medium 404 is three-dimensional, three-dimensional coordinates indicating the position where the work medium 404 is set inside the three-dimensional coordinate space representing the booth 400, for example, can be used as the position data. The position data of the work medium 404 may be constituted by a group of coordinates indicating the contour of the work medium 404 in the case of two dimensions or the surface of the work medium 404 in the case of three dimensions.

Furthermore, the work medium detection unit 303 determines whether or not the gaze direction of the user 401 estimated by the gaze estimation unit 302 is toward the work medium 404. In this case, it is sufficient that the work medium detection unit 303 determine whether or not the gaze direction of the user 401 is toward the work medium 404 in accordance with whether or not the extension of the vector indicating the gaze direction of the user 401 intersects with the work medium 404. For example, it is sufficient that the work medium detection unit 303 determine that the gaze direction of the user 401 is toward the work medium 404 in a case where the extension of the vector indicating the gaze direction of the user 401 intersects with the contour or surface of the work medium 404, and that the gaze direction of the user 401 is not toward the work medium 404 in a case where the extension of the vector indicating the gaze direction of the user 401 does not intersect with the contour or surface of the work medium 404.

Note that in a case where the work medium detection unit 303 detects types of work media 404, it is sufficient that the work medium detection unit 303 determine that the gaze of the user 401 is directed toward the work medium 404 in a case where the user 401's gaze is directed toward at least one work medium 404 among the types of work medium 404.

In a case where the work medium detection unit 303 determines that the gaze direction of the user 401 is toward the work medium 404, the content processing unit 304 changes the mode of the content image so that the level of visual attention of the user 401 decreases, and displays the content image with the changed mode on the screen 403.

The content processing unit 304 changes the mode of the content image, for example, by obscuring the content image. In this case the content processing unit 304 may increase the degree of obscuration of the content image as the length of time the user 401's gaze is directed toward the work medium 404 increases.

In a case where the content processing unit 304 determines that the user 401's gaze is not directed toward the work medium 404 after changing the mode of the content image, the content processing unit 304 may return the mode of the content image to the mode before the change, that is, the mode in which the content image is not obscured.

Note that, in the information processing system illustrated in FIG. 2, the database 200 and the processor 300 may be implemented in a single computer or distributed across computers. For example, the database 200 and the processor 300 may be configured using a cloud server or an edge server. In a case where the database 200 and the processor 300 are configured using a cloud server, the camera 402 and the screen 403 are communicatively connected to the database 200 and the processor 300 via an edge computer provided on the edge side.

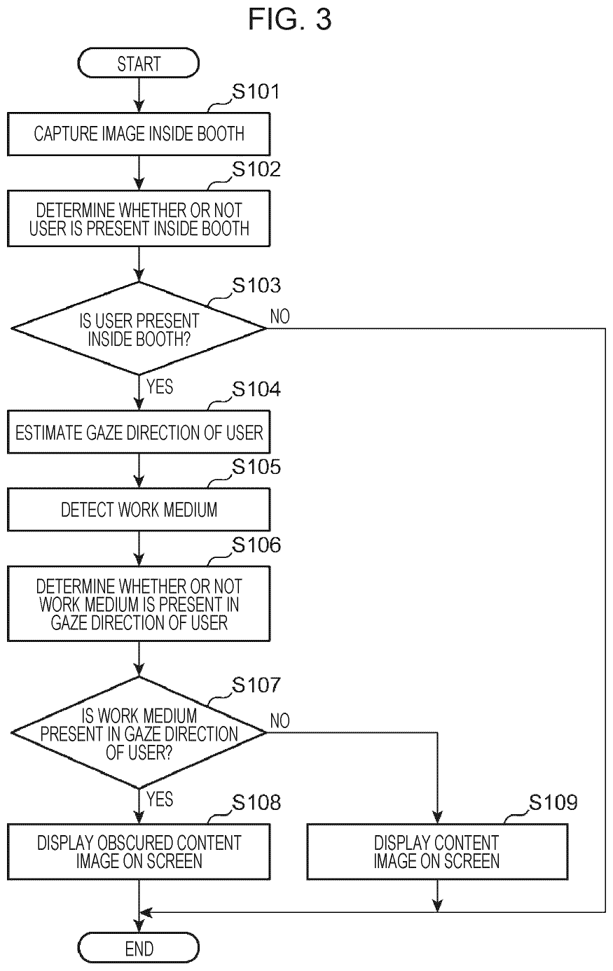

FIG. 3 is a diagram illustrating an example of a process performed by the information processing system 1 according to the embodiment of the present disclosure. The flowchart illustrated in FIG. 3 is repeatedly performed, for example, every time the camera 402 captures an image.

First, in Step S101, the camera 402 captures an image of the inside of the booth 400, and stores, in the sensor data database 202, the obtained image of the inside of the booth 400.

Next, in Step S102, the user determination unit 301 reads the latest image captured in Step S101 from the sensor data database 202 and uses the read image to determine whether or not the user 401 is present inside the booth 400. Hereinafter, the image to be processed is referred to as “target image”.

In a case where it is determined that the user 401 is present inside the booth 400 (YES in Step S103), the process proceeds to Step S104. In a case where it is determined that the user 401 is not present inside the booth 400 (NO in Step S103), the process ends.

Next, in Step S104, the gaze estimation unit 302 applies the above-mentioned gaze direction estimation technique to the target image to estimate the gaze direction of the user 401.

Next, in Step S105, the work medium detection unit 303 applies the above-mentioned object detection technique to the target image to detect the work medium 404.

Next, in Step S106, the work medium detection unit 303 determines whether or not the gaze direction estimated in Step S104 is toward the work medium 404 detected in Step S105.

In a case where it is determined that the work medium 404 is present in the gaze direction of the user 401 (YES in Step S107), the process proceeds to Step S108. In a case where it is determined that the work medium 404 is not present in the gaze direction of the user 401 (NO in Step S107), the process proceeds to Step S109.

In Step S108, the content processing unit 304 reads a content image to be displayed from the content database 201, applies an obscuration process to the read content image, and displays the obscured content image on the screen 403.

In Step S109, the content processing unit 304 reads the content image to be displayed from the content database 201, and displays the read content image on the screen 403 as it is.

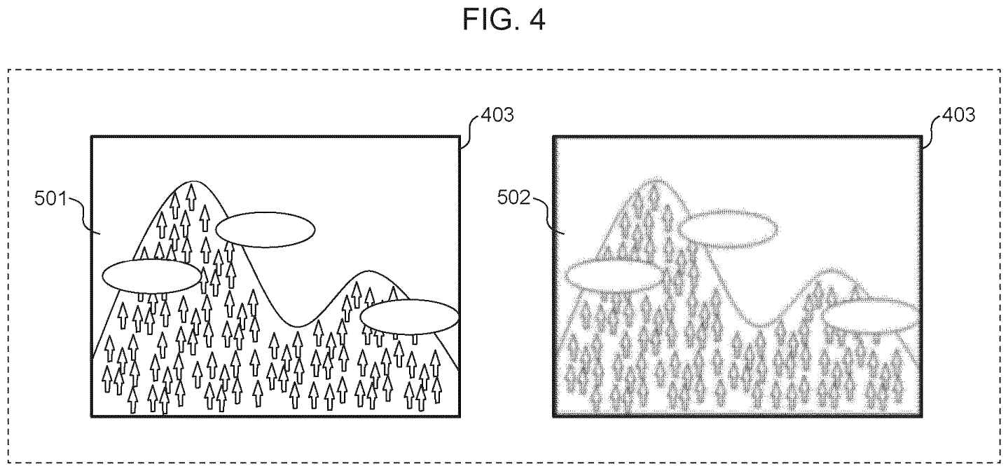

Next, the change of the mode of the content image will be described. FIG. 4 includes diagrams illustrating an example of the change of the mode of the content image. In FIG. 4, a content image 501 is a content image displayed on the screen 403 in a case where the gaze direction of the user 401 is not toward the work medium 404.

A content image 502 is a content image displayed on the screen 403 in a case where the gaze direction of the user 401 is toward the work medium 404. The content processing unit 304 generates the content image 502 by applying the obscuration process to the content image 501.

An example of the obscuration process is blurring. For example, the content processing unit 304 can divide the content image 501 into blocks and obscure the content image 501 by replacing the colors of the pixels in each block into the average color value of the pixels in the block. In this case, the degree of obscuration increases as the block size increases. Note that the content obscuration method is not limited to blurring. Thus, the content processing unit 304 may increase the degree of obscuration by increasing the size of the blocks set in the content image 501 or by increasing the number of times a blurring process is repeated.

In this case, the content processing unit 304 may gradually increase the degree of obscuration as the length of time the gaze direction of the user 401 remains toward the work medium 404 increases. By gradually increasing the degree of obscuration, it is possible to direct the user 401's attention to the work medium 404 naturally.

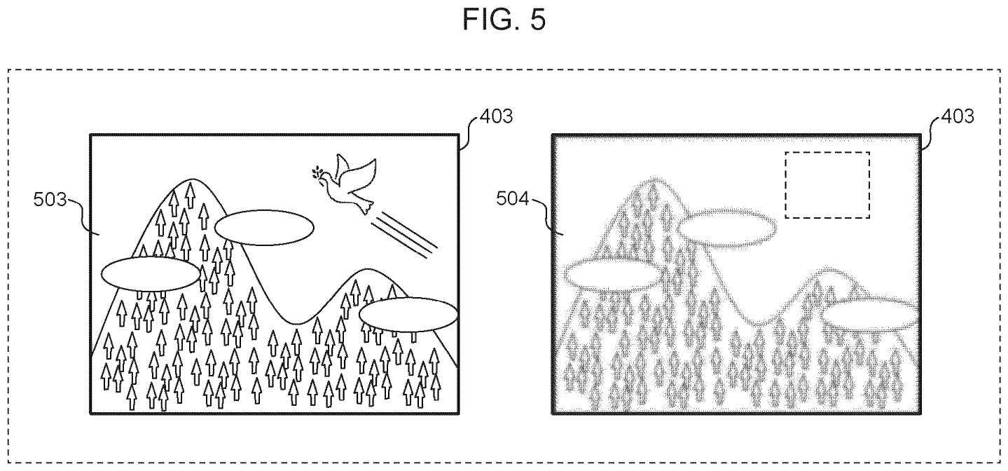

FIG. 5 includes diagrams illustrating another example of the change of the mode of the content image. A content image 503 is a content image displayed on the screen 403 in a case where the gaze direction of the user 401 is not toward the work medium 404. The content image 503 is a moving image constituted by frame images.

A content image 504 is a content image displayed on the screen 403 in a case where the gaze direction of the user 401 is toward the work medium 404. The content processing unit 304 generates the content image 504 by obscuring the content image 503 and then masking, using a mask image, a moving subject region of the obscured content image 503 where a highly dynamic moving subject is displayed.

As a method for determining moving subject regions, the following method can be used. First, the content processing unit 304 calculates the optical flow between a frame image of interest and the frame image immediately preceding the frame image of interest. Next, the content processing unit 304 extracts vectors having magnitudes greater than or equal to a threshold among the vectors that represent the calculated optical flow. Next, the content processing unit 304 identifies moving subject regions from the frame image of interest by clustering the extracted vectors. Next, the content processing unit 304 overwrites the moving subject regions with mask images.

In this case, the content processing unit 304 identifies the frame images of the time periods in which the vectors representing the optical flow are less than the threshold from among the frame images that constitute the content image 503, and extracts, as the mask images, regions corresponding to the moving subject regions from the identified frame images. Next, the content processing unit 304 can simply mask the identified moving subject regions by overwriting the identified moving subject regions with the extracted mask images.

Note that the content database 201 may store in advance time period information indicating, for each content image, which time periods correspond to the frame images including the moving subject regions. In this case, the content processing unit 304 can simply identify the frame images of the time periods the vectors representing the optical flow are less than the threshold, by referring to this time period information.

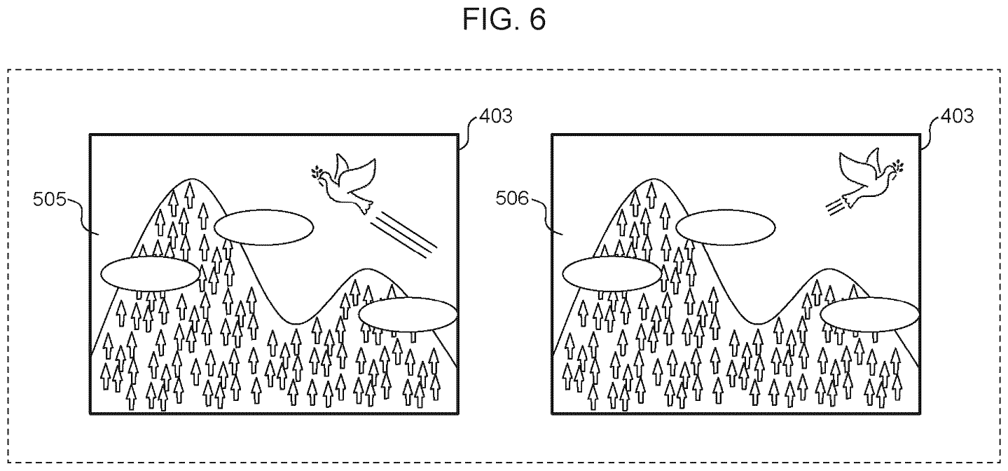

FIG. 6 includes diagrams illustrating yet another example of the change of the mode of the content image. In FIG. 6, a content image 505 is a content image displayed on the screen 403 in a case where the gaze direction of the user 401 is not toward the work medium 404.

A content image 506 is a content image displayed on the screen 403 in a case where the gaze direction of the user 401 is toward the work medium 404. The content image 506 has a smaller amount of movement than the content image 505. The amount of movement will be described below.

In a case where the gaze estimation unit 302 determines that the gaze direction of the user 401 is toward the work medium 404, the content processing unit 304 switches the content image displayed on the screen 403 from the content image 505 to the content image 506. In this manner, “change the mode of the content image” includes switching from a certain content image to another content image.

In this case, the content processing unit 304 can simply switch the content image 505 to the content image 506 on the basis of movement amount information stored in advance in the content database 201. The movement amount information is information that indicates the magnitude of movement (the amount of movement) of moving subjects included in each content image. For example, the amount of movement is defined by the length of the time period of the frame images including the moving subject regions calculated through the above-mentioned process. In this case, the content processing unit 304 can simply identify, from the content database 201, the content image 506 that has movement amount information indicating the amount of movement smaller than that indicated by the movement amount information of the content image 505.

The amount of movement may be either one or a combination of the maximum value among the sizes of the moving subject regions included in the content image and the maximum value among the magnitudes of the movements of the moving subjects included in the content image. The sizes of the moving subject regions are, for example, the sizes of the regions obtained by clustering the vectors representing the optical flow. The magnitudes of the movements of the moving subjects are, for example, the averages of the magnitudes of the vectors representing the optical flow included in the moving subject regions.

Note that, among the frame images constituting a certain single content image, the content processing unit 304 may switch the content image displayed on the screen 403 by skipping to a frame image that does not include a moving subject region.

In this case, during the playback of the content image, the content processing unit 304 determines, by referring to the above-mentioned time period information, whether or not it is time to play back the frame image including the moving subject region. In a case where the content processing unit 304 determines that it is time to play back the frame image including the moving subject region, the content processing unit 304 identifies, by referring to the time period information, the most recent frame image that does not include the moving subject region among the subsequent frame images. The content processing unit 304 can then simply display the identified frame image that does not include the moving subject region on the screen 403. By repeating this process, the content processing unit 304 can display the content image having a small amount of movement on the screen 403 in a case where the gaze direction of the user 401 is toward the work medium 404.

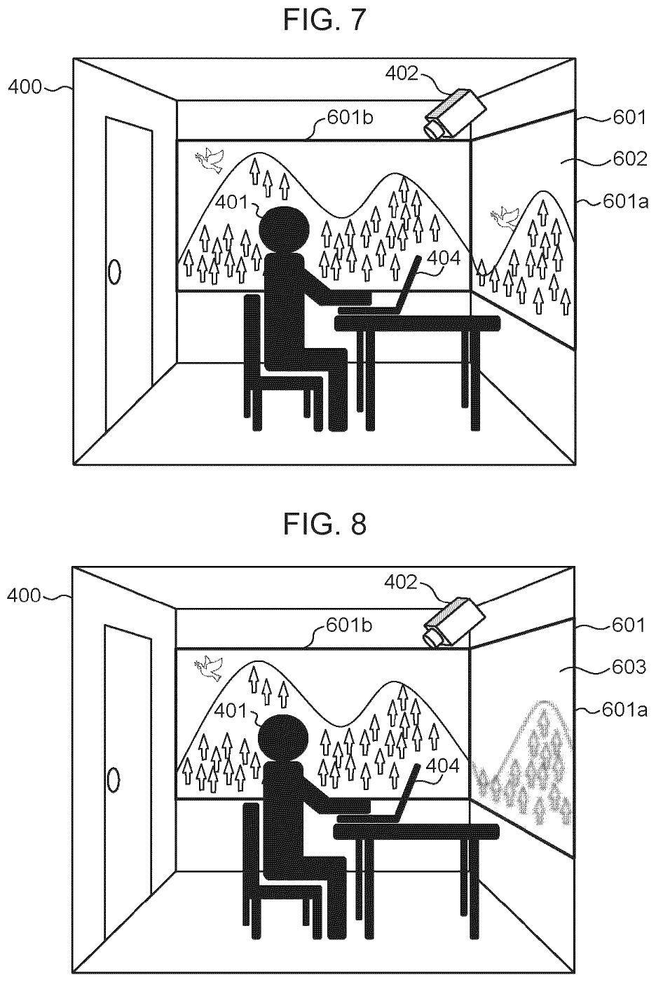

FIGS. 7 and 8 are diagrams illustrating yet other examples of the change of the mode of the content image. FIG. 7 illustrates a case where the gaze direction of the user 401 is not toward the work medium 404. FIG. 8 illustrates a case where the gaze direction of the user 401 is toward the work medium 404.

As illustrated in FIGS. 7 and 8, a screen 601 includes a first display region 601a and a second display region 601b. The first display region 601a is located in front of the user 401. The second display region 601b is located to the left and right of the user 401. Note that, in FIGS. 7 and 8, the illustration of the second display region 601b located to the right of the user 401 is omitted for convenience's sake. In this manner, the screen 601 has a configuration that surrounds the user from the front, left, and right sides, and can display a panoramic content image 602. Thus, the screen 601 can provide the user 401 with a sense of immersion. The content image 602 may also be a moving image.

In the examples in FIGS. 7 and 8, similarly to the above-mentioned examples, the content processing unit 304 can change the mode of the content image. That is, in a case where the gaze estimation unit 302 determines that the gaze direction of the user 401 is not toward the work medium 404, the content processing unit 304 performs an obscuration process, a mask process, a content image switching process, and the like on the content image 602.

Specifically, in a case where the gaze estimation unit 302 determines that the gaze direction of the user 401 is toward the work medium 404, the content processing unit 304 changes the mode of the content displayed in the first display region 601a, and maintains the mode of the content displayed in the second display region 601b. In the example in FIG. 8, the content image 602 displayed in the second display region 601b is not obscured, but the content image 602 displayed in the first display region 601a is obscured.

In this manner, in the examples in FIGS. 7 and 8, in a case where the gaze of the user 401 is not directed toward the work medium 404, the screen 601 displays the content image 602 extensively over the first display region 601a and the second display region 601b, and thus the user 401 can be provided with a greater sense of immersion. In contrast, in a case where the gaze of the user 401 is directed toward the work medium 404, the mode of the content image 602 displayed in the second display region 601b of the screen 601 is maintained, but the mode of the content image 602 displayed in the first display region 601a of the screen 601 is changed. Thus, the user's attention can be effectively directed to the work medium 404. Furthermore, the processing load of the processor 300 in a case where the processor 300 does not change the mode of the content image 602 displayed in the second display region 601b but changes the mode of the content image 602 displayed in the first display region 601a is lower than the processing load of the processor 300 for a case where the processor 300 changes the mode of the content image 602 displayed in the second display region 601b and changes the mode of the content image 602 displayed in the first display region 601a.

As described above, according to the present embodiment, whether or not the gaze of the user 401 is directed toward the work medium 404 is determined, and thus it is possible to accurately determine whether or not the user 401 is concentrating on the task performed using the work medium 404. In a case where it is determined that the gaze of the user 401 is directed toward the work medium 404, the mode of the content image is changed so that the level of visual attention of the user 401 decreases, and thus the user 401's attention can be directed to the work medium 404 and the decline in the user's concentration on such a task can be suppressed. In contrast, in a case where the user's gaze is not directed toward the work medium 404, the user's attention can be directed to the content image to enhance the user's sense of relaxation, for example, and work productivity can be improved.

The following modifications of the present disclosure can be employed.
(1) The gaze estimation unit 302 may acquire potential differences (eye voltages) between the cornea side and the retina side of the eye balls of the user 401, the potential differences being detected by electrodes (an example of a sensor) that are in contact with the periphery of the user's eyes, and may estimate the gaze direction of the user 401 on the basis of the acquired potential differences. Details of this method are disclosed in, for example, Japanese Unexamined Patent Application Publication No. 2018-82727.
(2) The content processing unit 304 may identify the field of view of the user 401 on the screen 403 or in the first display region 601a using the gaze direction of the user 401 estimated by the gaze estimation unit 302, and may obscure the content image within the identified field of view but does not have to obscure the content image in the region that is not included in the identified field of view. In this case, the content processing unit 304 can simply calculate a viewing cone centered on the viewing direction, and the plane where the viewing cone intersects with the screen 403 or first display region 601a can be simply identified as the field of view.
(3) In a case where the gaze estimation unit 302 determines that the gaze direction of the user 401 is toward the work medium 404, the content processing unit 304 may reduce the luminance of the content displayed on the screen 403 below the default luminance value. This can direct the user's attention to the work medium. Note that, in the example in FIG. 8, the content processing unit 304 can simply reduce the luminance of the first display region 601a below the default luminance. In this case, the luminance may be gradually reduced as the time the gaze direction of the user 401 remains toward the work medium 404 increases.
(4) In a case where the work medium 404 is a computer equipped with a display, the content processing unit 304 acquires luminance information regarding the luminance of the display of the computer. The content processing unit 304 may reduce the luminance of the content displayed on the screen 403 so that the luminance of the content becomes lower than the luminance of the display indicated by the acquired luminance information. In a case where the work medium 404 and the information processing system 1 are connected via a network, the content processing unit 304 can simply acquire the luminance information regarding the display via the network.
(5) In a case where the content processing unit 304 returns the changed mode of the content image to its previous mode, the content processing unit 304 may return the mode instantly. Alternatively, the content processing unit 304 may perform processing for gradually returning the changed mode to the previous mode as the period of time the gaze of the user 401 remains away from the work medium 404 increases. For example, in a case where the change of the mode of the content image corresponds to the obscuration of the content image and where it is determined that the gaze direction of the user 401 is not directed toward the work medium 404, it is sufficient that the degree of obscuration be gradually reduced to change, in stages, the content image into the content image that is not obscured.
   This can reduce the sense of discomfort experienced by the user 401.
(6) In the example in FIG. 5, the content image 504 is obscured and the moving subject region where the highly dynamic moving subject is displayed is masked; however, the content image 504 does not have to be obscured and the moving subject region where the highly dynamic moving subject is displayed may be masked.
(7) Other 1

The space for the user 401 to perform tasks using the work medium 404 may be the space inside a moving object.

During the period in which the user 401 performs tasks, the moving object may be stationary or in motion.

For example, the moving object may be a vehicle.

The processor 300 may be an Electronic Control Unit (ECU) that comes standard with the vehicle or may be configured separately from the ECU.

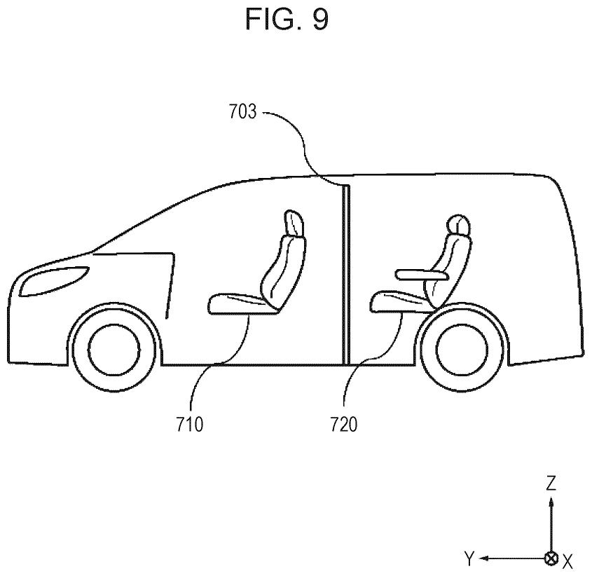

FIG. 9 is a diagram illustrating an example of a vehicle. As illustrated in FIG. 9, a screen 703 that displays a content image may be located in the vehicle.

As the camera 402, a camera installed in a personal computer may be used. A camera located at a position that is inside the vehicle and from which images of the work medium and the user can be captured may also be used.

The user 401 may perform tasks in the rear seat of the vehicle, and the camera may be located at a position from which images of rear seats 720 of the vehicle can be captured.

The screen 703 may be located between front seats 710 of the vehicle and the rear seats 720 of the vehicle. The front seats 710 include a driver's seat and a passenger seat.

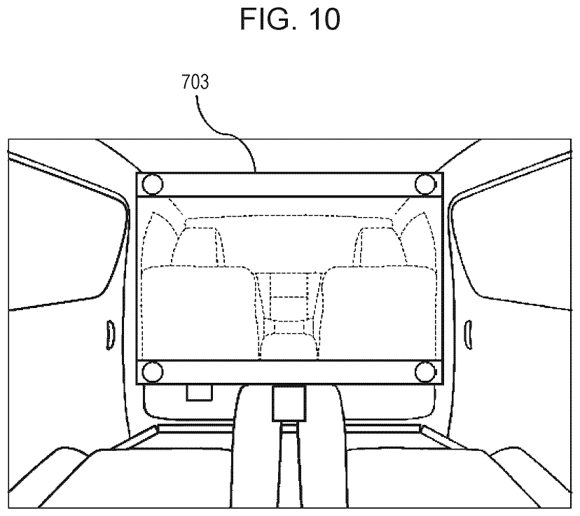

FIG. 10 is a diagram schematically illustrating an example of the scene when looking at the front seats 710 from the rear seats 720 illustrated in FIG. 9. The screen 703 may include a light-adjustable sheet with adjustable transmittance. By adjusting the transmittance, the information processing system may be configured to allow the user to visually recognize the direction of travel of the vehicle from the rear seats 720 through the screen 703.

The screen 703 has a back surface and a display surface where images are displayed. The display surface may be positioned on the rear seat 720 side, and the back surface may be positioned on the front seat 710 side. That is, the screen 703 may be located to present content images to a user who performs tasks or has a meeting using, for example, a computer in the rear seat. The distance between the display surface and the rear seats 720 may be shorter than the distance between the back surface and the rear seats 720.

In a case where images are projected onto the screen using a projector, the projector may be located inside the moving object.

Even when the space for the user to perform tasks is a space inside the moving object, the information processing system 1 may perform substantially the same operations as in the flowchart illustrated in FIG. 3.
(8) Other 2

The information processing method according to the present disclosure may be applied for users.

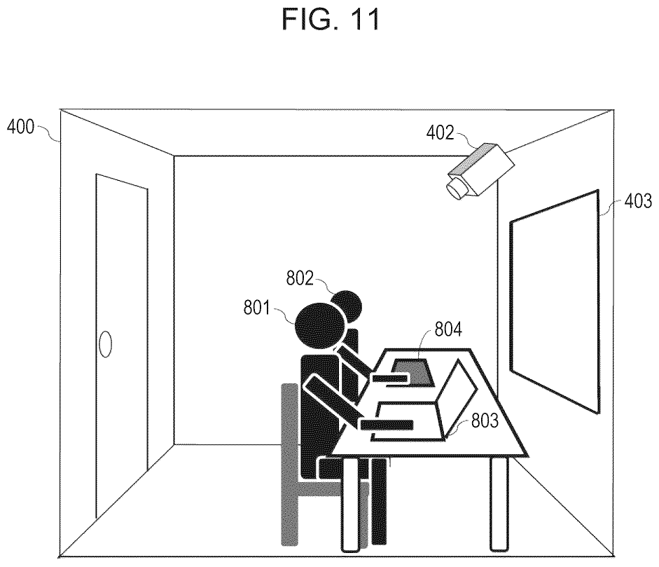

FIG. 11 is a diagram illustrating an example of a case where users use the booth 400. In FIG. 11, the users include a first user 801 and a second user 802. The first user 801 is performing a task using a personal computer 803 as a work medium, and the second user 802 is performing a task using a notebook 804 as a work medium. Unlike the example illustrated in FIG. 11, the users may include three or more users.

In FIG. 11, there is one camera 402 observing the inside of the booth 400; however, cameras may be located inside the booth 400, and cameras for capturing images of the respective users on a one-to-one basis may be located inside the booth 400. As the cameras, cameras installed in the work media used by the respective users may be used.

In FIG. 11, there is one screen 403 for displaying a content image; however, screens may be located inside the booth 400, and screens for displaying a content image for the respective users on a one-to-one basis may be located inside the booth 400. The screens may be located so as to face the respective users.

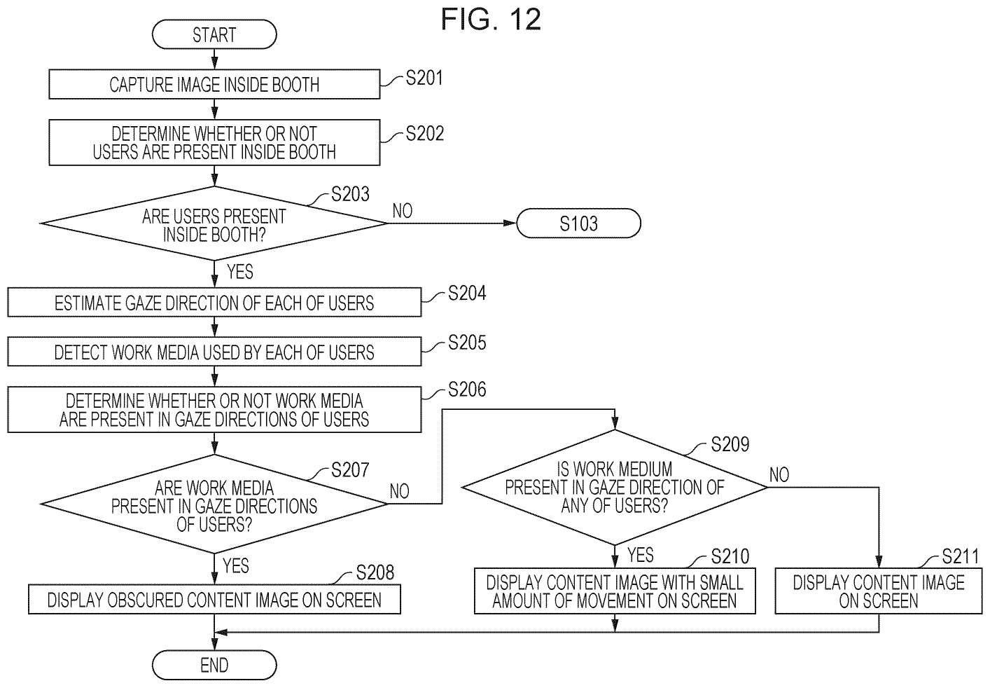

FIG. 12 is a diagram illustrating an example of a process performed by the information processing system 1 in a configuration assuming that users use the booth 400.

Step S201 is substantially the same as Step S101.

In Step S202, the user determination unit 301 reads the latest image captured in Step S201 from the sensor data database 202 and uses the read image to determine whether or not users are present inside the booth 400. Hereinafter, the image to be processed is referred to as “target image”.

In a case where it is determined that users are present inside the booth 400 (YES in Step S203), the process proceeds to Step S204. In a case where it is determined that users are not present inside the booth 400 (NO in Step S203), the process proceeds to Step S103 in FIG. 3. In this embodiment, in a case where it is determined that two or more users are present inside the booth 400, it may be determined that users are present inside the booth 400. In a case where it is determined that a single user is present inside the booth 400 or a case where it is determined that no user is present inside the booth 400, it may be determined that users are not present inside the booth 400.

In Step S204, the gaze estimation unit 302 applies the above-mentioned gaze direction estimation technique to the target image to estimate the gaze direction of each of the users.

In Step S205, the work medium detection unit 303 applies the above-mentioned object detection technique to the target image to detect work media used by each of the users.

In Step S206, the work medium detection unit 303 determines whether or not the gaze directions of the users estimated in Step S204 are toward the work media detected in Step S205. For example, in a case where the users include a first user and a second user, the work medium detection unit 303 determines whether or not the gaze direction of the first user is toward a first work medium used by the first user and determines whether or not the gaze direction of the second user is toward a second work medium used by the second user.

In a case where it is determined that the work media are present in the gaze directions of the users (YES in Step S207), the process proceeds to Step S208. In a case where it is determined that the work media are not present in the gaze directions of the users (NO in Step S207), the process proceeds to Step S209. The case where it is determined that the work media are present in the gaze directions of the users may be a case where it is determined that the gaze directions of each of all users performing tasks inside the booth 400 are toward the work media corresponding to all the respective users on a one-to-one basis. For example, in a case where the work medium detection unit 303 determines that the gaze direction of the first user is toward the first work medium used by the first user and the gaze direction of the second user is toward the second work medium used by the second user, the work medium detection unit 303 determine that the work media are present in the gaze directions of each of the users. In a case where the work medium detection unit 303 determines that at least one of the gaze direction of the first user or the gaze direction of the second user is not toward the work medium, the work medium detection unit 303 determines that the work media are not present in the gaze directions of each of the users.

In Step S208, the content processing unit 304 reads a content image to be displayed from the content database 201, applies an obscuration process to the read content image, and displays the obscured content image on the screen 403. In a case where the screens corresponding to each of the users are provided inside the booth 400, the obscured content image may be displayed on each of the screens. Instead of applying the obscuration process to the read content image in Step S208, a process for changing the region corresponding to the moving subject included in the read content image to the background image corresponding to the region may be applied, and the resulting image may be displayed on the screen 403. Alternatively, a process for reducing the luminance of the read content image may be applied, and the resulting image may be displayed on the screen 403.

In a case where it is determined that the work medium is present in the gaze direction of any of the users (YES in Step S209), the process proceeds to Step S210. In a case where it is determined that no work medium is present in the gaze direction of any of the users (NO in Step S209), the process proceeds to Step S211. For example, in a case where the work medium detection unit 303 determines that the gaze direction of the first user is toward the first work medium used by the first user or a case where the gaze direction of the second user is toward the second work medium used by the second user, the work medium detection unit 303 determines that the work medium is present in the gaze direction of any of the users. In a case where the work medium detection unit 303 determines that the gaze direction of the first user is not toward the first work medium used by the first user and a case where the gaze direction of the second user is not toward the second work medium used by the second user, the work medium detection unit 303 determines that no work medium is present in the gaze direction of any of the users.

In Step S210, the content processing unit 304 reads, from the content database 201, the content image that has movement amount information indicating a small amount of movement, and displays the read content image on the screen 403. In a case where a content image is displayed on the screen 403 at Step S209, the content image having a smaller amount of movement than the content image that is already displayed may be displayed in Step S210.

In Step S211, the content processing unit 304 reads a content image to be displayed from the content database 201 and displays the read content image on the screen 403. The amount of movement of the content image displayed in Step S211 may be larger than the amount of movement of the content image displayed in Step S210. In a case where a content image is displayed on the screen 403 at Step S209, Step S211 may be an operation for maintaining the display of the content image that is already displayed.

The target image to be processed may include target images. The target images may include a first target image corresponding to the first user and a second target image corresponding to the second user.

As described above, in an example of the process illustrated in FIG. 12, in a case where the gaze directions of all users performing tasks inside the booth 400 are toward the work media, the mode of the content image displayed on the screen 403 is changed so that the levels of visual attention of all users decrease, and thus the decline in all users' concentration can be suppressed.

In a case where the gaze direction of any of the users performing tasks inside the booth 400 is toward the work medium and where the gaze direction of another user is not toward the work medium, the content image with a small amount of movement is displayed. Thus, while suppressing the decline in concentration of users who are concentrating on their tasks, for example, the sense of relaxation in users who are not concentrating on tasks can be enhanced, and the work productivity of the users who are not concentrating on tasks can be improved.

According to the present disclosure, the decline in users' concentration on tasks performed using work media can be suppressed, and thus the present disclosure is useful in the technical field of improving work environment.

What is claimed is:

1. An information processing method performed by a computer, comprising:
displaying a content image on a display;
determining whether or not a user's gaze is directed toward a work medium for the user to perform a task; and
changing, in a case where it is determined that the user's gaze is directed toward the work medium, a mode of the content image displayed on the display so that a level of visual attention of the user decreases.

2. The information processing method according to claim 1, wherein
changing the mode of the content image includes obscuring the content image.

3. The information processing method according to claim 2, wherein
in a case where it is determined that the user's gaze is directed toward the work medium, a degree of obscuration of the content image is increased in accordance with a length of time the user's gaze remains directed toward the work medium.

4. The information processing method according to claim 1, wherein
the content image is a moving image, and
changing the mode of the content image is changing a region corresponding to a moving subject included in the content image to a background image corresponding to the region.

5. The information processing method according to claim 1, wherein
changing the mode of the content image includes reducing luminance of the content image.

6. The information processing method according to claim 1, wherein
in a case where it is determined that the user's gaze is not directed toward the work medium after changing the mode of the content image, the mode of the content image is returned to a mode used before changing the mode of the content image.

7. The information processing method according to claim 1, wherein
the display includes a first display region facing the user and a second display region different from the first display region,
displaying the content image on the display includes displaying the content image in the first display region and the second display region, wherein a first content image included in the content image is displayed in the first display region, and a second content image included in the content image is displayed in the second display region, and
changing the mode of the content image includes changing a mode of the first content image and maintaining a mode of the second content image.

8. The information processing method according to claim 1, wherein
the content image includes a first content moving image and a second content moving image having a smaller amount of movement than the first content moving image, and
in a case where it is determined that the user's gaze is directed toward the work medium, the first content moving image displayed on the display is changed to the second content moving image.

9. The information processing method according to claim 1, wherein
the content image is an image that creates an ambience around the user.

10. The information processing method according to claim 1, wherein
determining whether or not the user's gaze is directed toward the work medium includes performing a determination using sensing data detected by a sensor that detects at least a state of an eye of the user.

11. An information processing system comprising:
a processor, wherein
the processor
displays a content image on a display,
determines whether or not a user's gaze is directed toward a work medium for the user to perform a task, and
performs, in a case where it is determined that the user's gaze is directed toward the work medium, a process for changing a mode of the content image displayed on the display so that a level of visual attention of the user decreases.

12. The information processing method according to claim 1, wherein
the display includes a back surface and a display surface where the content image is displayed,
the display is located between a front seat of a vehicle and a rear seat of the vehicle, and
a distance between the display surface and the rear seat is shorter than a distance between the back surface and the rear seat.
